(19) United States
(12) Patent Application Publication
(10) Pub. No.: US 2015/0058060 A1
(43) Pub. Date: Feb. 26, 2015

(54) Method, Device, Client And System Of Affair Reminder

(71) Applicant: TENCENT TECHNOLOGY (SHENZHEN) COMPANY LIMITED, Shenzhen City (CN)

(72) Inventors: Yong TAO, Shenzhen City (CN); Ning MA, Shenzhen City (CN); Sha MO, Shenzhen City (CN); Zhou FENG, Shenzhen City (CN)

(21) Appl. No.: 14/532,038

(22) Filed: Nov. 4, 2014

Related U.S. Application Data
(63) Continuation of application No. PCT/CN2013/074613, filed on Apr. 24, 2013.

(30) Foreign Application Priority Data
May 4, 2012 (CN) 201210137254.9

(51) Int. Cl. G06Q 10/10

(52) U.S. Cl. CPC G06Q 10/1095
USPC 705/7.19

(57) ABSTRACT

A method, device, client and system for implementing reminders. The method includes: receiving from a first client affair reminder information and information of a second client; sending the affair reminder information to the second client according to the information of the second client, so that the second client can perform affair reminding according to the affaire reminder information. The device includes an information receiving module and an affair reminding module. The client includes a receiving module and an affair reminding module. The system includes a first client, a device of affair reminder and a second client. The affair reminder information can be sent by the first client to the second client so as to enable the second client to perform affair reminding according to the affair reminder information.

### CROSS-REFERENCE TO RELATED APPLICATIONS

This application is a continuation of International Application No. PCT/CN2013/074613 filed on Apr. 24, 2013. This application claims the benefit and priority of Chinese Application No. 201210137254.9 filed May 4, 2012. The entire disclosures of each of the above applications are incorporated herein by reference.

### FIELD

The present disclosure relates to a field of a computer and to a method, device, client and system of affair reminder.

### BACKGROUND

With the accelerating pace of people's daily lives, people interact more and more to manage affairs. A user may use reminders to track important affairs like an important meeting or function.

An affair reminding method in the prior art adopts an interactive way in which a requester notifies an executer orally or by way of texts and the executer sets a reminding time. The executer may configure the reminder for a certain affair through program scheduling software and an alarm clock. Using program scheduling software, a user may make a program schedule according to scheduled time, and the user may input his/her own schedule program to a device and set a timing reminder function. The user may also set an alarm clock to remind of a special time, and the timer can play the role of a reminder.

However, an executer may forget or lose the affair passed on by the requestor during the affair reminding procedure.

### SUMMARY

This section provides a general summary of the disclosure, and is not a comprehensive disclosure of its full scope or all of its features.

An embodiment of the present disclosure provides a method of affair reminder including:

receiving affair reminder information of a first client and information of a second client; and

sending the affair reminder information to the second client according to the information of the second client so as to enable the second client to perform affair reminding according to the affair reminder information.

Another embodiment of the present disclosure provides a device of affair reminder including:

an information receiving module, adapted to receive from a first client affair reminder information and information of a second client; and

an affair reminding module, adapted to send the affair reminder information to the second client according to the information of the second client received by the information receiving module so as to enable the second client to perform affair reminding according to the affair reminder information.

Another embodiment of the present disclosure provides a second client of affair reminder including:

a receiving module, adapted to receive affair reminder information; and

an affair reminding module, adapted to perform affair reminding according to the affair reminder information received by the receiving module.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

To illustrate technical schemes in various embodiments of the present disclosure more clearly, drawings used to describe various embodiments will be simply introduced hereinafter. The following described drawings relate to various embodiments of the present disclosure, and to one skilled in the art, other drawings can be acquired according to these drawings without paying any inventive labors.

FIG. 1 is a flowchart illustrating the method of affair reminder according to various embodiments;

FIG. 2a is a flowchart illustrating the method of affair reminder provided by various embodiments;

FIG. 2b is a flowchart illustrating the method of affair reminder according to various embodiments;

FIG. 3 is a diagram illustrating disadvantages of traditional affair reminding method according to various embodiments;

FIG. 4 is a structural diagram illustrating the method of affair reminder according to various embodiments;

FIG. 5 is a diagram illustrating a structure of the device of affair reminder according to various embodiments;

FIG. 6 is a diagram illustrating a structure of a second client for affair reminder according to various embodiments;

FIG. 7 is a diagram illustrating a structure of the second client for affair reminder according to various embodiments; and

FIG. 8 is a diagram illustrating a structure of the system of affair reminder according to various embodiments.

Corresponding reference numerals indicate corresponding parts throughout the several views of the drawings.

### DETAILED DESCRIPTION

Example embodiments will now be described more fully with reference to the accompanying drawings.

In order to make objectives, technical schemes, and advantages of the present invention clearer, the various embodiments of the present disclosure will be illustrated in further detail with reference to the drawings.

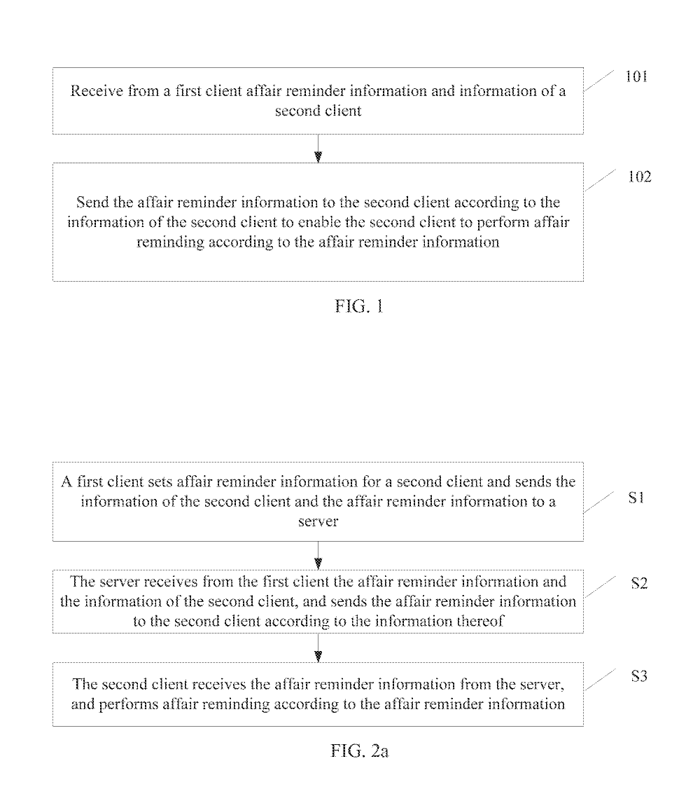

With reference to FIG. 1, various embodiments provide a method of affair reminder, including the following.

Block 101: receiving affair reminder information form a first client and information of a second client.

Block 102: according to the information of the second client, sending the affair reminder information to the second client to enable the second client to perform affair reminding according to the affair reminder information.

According to the information of the second client, the affair reminder information sent by the first client is sent to the second client, so that the second client can perform affair reminding according to the affair reminder information. Thus, the function of automatically reminding the user is implemented and the situation of the executer forgetting or losing an affair can be prevented.

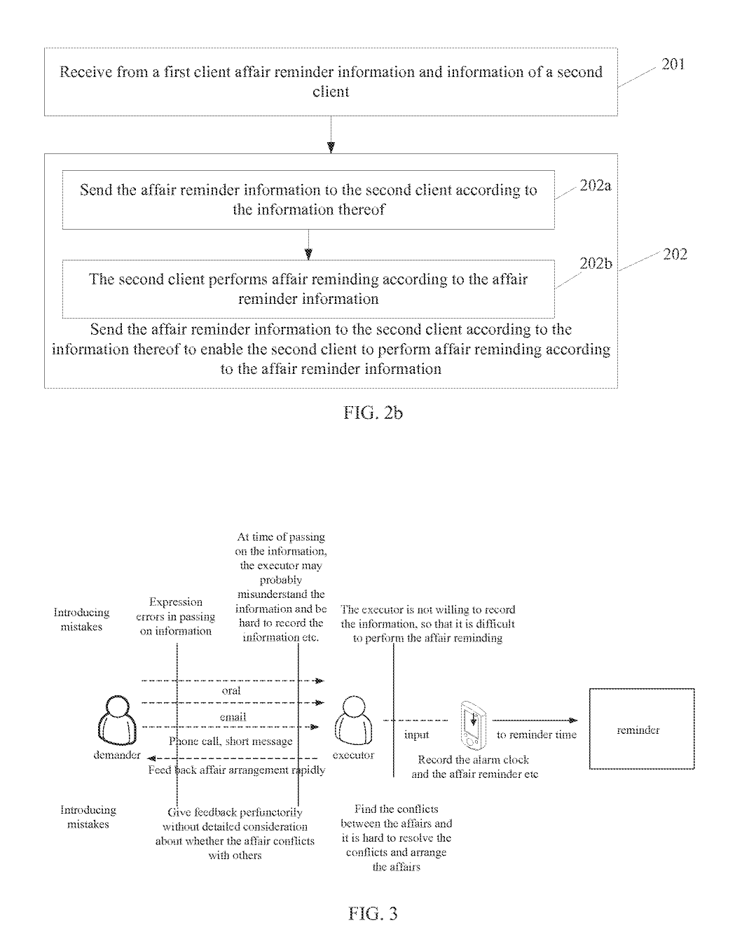

With reference to FIG. 2a, various embodiments further provide a method of affair reminder, including the following.

Block S1: the first client setting affair reminder information for the second client and sending this affair reminder information and information of the second client to a server.

Block S2: the server receiving the affair reminder information and the information of the second client sent by the first client and, according to the information of the second client, sending the affair reminder information to the second client.

Block S3: the second client receiving the affair reminder information sent by the server, and performing affair reminding according to the received affair reminder information.

In various embodiments, the first client may send the affair reminder information in various trigger ways, including, but not limited to, at least one of the following ways: setting a special button in an interface of the first client, when the user finishes setting the affair reminder information and pushes this button, triggering the first client to send this affair reminder information and the information of the second client to the server; or, the first client presetting an affair reminding rule and automatically recognizing whether information input by the user to the first client accords with the preset affair reminding rule. If the information accords with the rule, obtaining the affair reminder information according to the information input by the user and sending this information together with the information of the second client to the server. Other ways can be adopted to trigger the first client to send the affair reminder information to the server, which are not limited by the various embodiments.

In various embodiments, the second client can be a terminal with an affair reminder function. This terminal is capable of receiving information sent by the server and includes, but is not limited to, a computer, a lap top, a mobile phone, a tablet computer, and so on, which is not limited by the various embodiments.

In the various embodiments, the first client and the second client may be different terminals or the same terminal. When the first client and the second client are different terminals, the above-mentioned method is applied to the situation when a terminal's user triggers an affair reminder to another terminal's user. When the first client and the second client are the same terminal, the above-mentioned method is applied to the situation when a terminal's user performs an affair reminder to himself/herself.

With reference to FIG. 2b, the method of affair reminder will be introduced in detail hereinafter.

Block 201: receiving from the first client affair reminder information and information of the second client. In the various embodiments, the first client may be a client corresponding to a demander who is a sponsor of an affair, such as an organizer of a conference, a user that has to remind someone of something, an initiator of a meeting, etc. The second client may be a client corresponding to an executer who executes the affair, such as a participant of a meeting, the user who needs to remember something, the executer who is demanded or requested of something, etc. The information of the second client is the information of the client corresponding to the executer, such as an identifier or address of the client corresponding to this executer.

The affair reminder information and the information of the second client sent by the first client may be carried in the same data packet and may be sent to the server together, or may be carried in different data packets and sent to the server separately. The affair reminder information includes, but is not limited to, an affair reminding topic, affair reminding time, affaire reminder frequency, and an affair reminding manner set by the user.

Herein, the affair reminder information is set through social software on the user's demand. The social software may be QQ software, MSN or microblog, and so on. There are multiple ways to set the affair reminder information, including, but not limited to, the following: a text manner, a voice manner, etc. For example, a user inputs text messages to a text edit box in the social software to set up the affair reminder information, or the user inputs voice information through the social software's recording function to set up the affair reminder information.

The social software may enable the client corresponding to the demander to set up the affair reminder information for a certain executer and to send this affair reminder information to the client corresponding to this executer. Meanwhile, this social software may also implement real-time interaction and communication between the client corresponding to the executer and the client corresponding to the demander. The social software may be deployed in either a mobile device or in a non-mobile device, which can help expand application scope of affair reminder in actual lives. A server is set in various embodiments of the present disclosure to receive the affair reminder information of the first client and the information of the second client sent by the first client, where the server may be a separate server or a server integrated in a server of other applications, like a server of QQ software, MSN, microblog, etc.

One embodiment implemented using QQ software is as follows: when a client A selects a friend B from his own friend list and sends affair reminder information to the friend B, this affair reminder information includes “attend a classmate reunion in Room 403 in a hotel in Beijing at 10 am on Jan. 10, 2012”, and then, a QQ server will receive the affair reminder information sent by the client A and an identifier of a client B.

Block 202: according to the information of the second client, sending the affair reminder information to the second client so that the second client can perform affair reminding according to the affair reminder information. In the various embodiments, this block includes the following blocks as follow:

Block 202a: according to the information of the second client, sending the affair reminder information to the second client.

Block 202b: the second client performing affair reminder according to the affair reminder information.

In the various embodiments, the second client performs affair reminding according to the affair reminding information and a judgment can be made as follows. The second client judges whether the received affair reminder information conflicts with the affair reminder information in the current database. If the received affair reminder information does not conflict with the affair reminder information in the current database, the second client adds the received affair reminder information to the current affair reminder information data table for affair reminding.

For example, the second client receives a piece of affair reminder information such as, “attend a classmate reunion in Room 403 in a hotel in Beijing at 10 am on Jan. 10, 2012”, and the second client inquires data information in the current database. If it is presented in the current database that there is no data information at 10 am on Jan. 10, 2012, the second client adds the affair reminder information of “attend a classmate reunion in Room 403 in a hotel in Beijing at 10 am on Jan. 10, 2012” to the current affair reminder information data table for affair reminding. The second client performs affair reminding according to the affair reminding manner, reminding time, and affair reminding frequency set by the user, and accomplishes the procedure of the affair reminding through affair reminder software.

If it is set by the user that a reminder is made every half hour from two hours before the affair starts, the user is reminded of the affair at 8:00 am, 8:30 am, 9:00 am, 9:30 am, and 10:00 am on Jan. 10, 2012 using different reminding ring tones while the affair reminder information is played, so that the user can schedule a proper time to go. Here, the affair reminding software includes schedule program software, and the user can make a schedule program according to schedule time and use the software to input his schedule program to the device for the purpose of timing the reminder. The affair reminding software may be deployed in a mobile device or in a non-mobile device, which can help expand application scope of affair reminder in actual lives.

If the received affair reminder information conflicts with the affair reminder information in the current database, the second client modifies the received affair reminder information and adds the modified affair reminder information to the current affair reminder information data table for affair reminding, or deletes the received affair reminder information. More specifically, if the received affair reminder information conflicts with the affair reminder information in the current database, the second client modifies the received affair reminder information and adds the modified affair reminder information to the current affair reminder information data table for affair reminding. There are two modification manners specifically as follow:

First, through receiving a user modification instruction from the client corresponding to the executer, modifying the received affair reminder information, and adding the modified affair reminder information to the current affair reminder information data table for affair reminding.

For example, the second client receives affair reminder information such as, “Attend a classmate reunion in Room 403 in a hotel in Beijing at 10 am on Jan. 10, 2012”, and the second client inquires data information in the current data base. If it is revealed in the current database that there is data information of an affair to attend at 10 am on Jan. 10, 2012, the second client notifies the executer of this affair reminder information. The executer sends a modification instruction. The second client receives a user modification instruction from the client corresponding to the executer such as, “Put off this affair reminding time for one hour”, and modifies the received affair reminder information to “Attend a classmate reunion in Room 403 in a hotel in Beijing at 11 am on Jan. 10, 2012”, and adds the modified affair reminder information “Attend a classmate reunion in Room 403 in a hotel in Beijing at 11 am on Jan. 10, 2012” to the current affair reminder information data table for affair reminding.

Second, through a preset modification strategy of the client corresponding to the executer, modifying the received affair reminder information and adding the modified affair reminder information to the current affair reminder information data table for affair reminding.

For example, the second client receives affair reminder information such as, “Attend a classmate reunion in Room 403 in a hotel in Beijing at 10 am on Jan. 10, 2012” and the second client inquires the data in the current database. If it is revealed that there is data information of a meeting to attend at 10 am on Jan. 10, 2012 in the current database, the second client modifies the information according to the preset strategy. If the received affair reminder information conflicts with the affair reminder information in the current database, put off the received affair reminder information for one hour. According to the preset modifying strategy, the second client modifies the received affair reminder information of “Attend a classmate reunion in Room 403 in a hotel in Beijing at 10 am on Jan. 10, 2012” to “Attend a classmate reunion in Room 403 in a hotel in Beijing at 11 am on Jan. 10, 2012”, and adds the modified affair reminder information “Attend a classmate reunion in Room 403 in a hotel in Beijing at 11 am on Jan. 10, 2012” to the current affair reminder information data table for affair reminding. Meanwhile, the second client returns the modified affair reminder information of “Attend a classmate reunion in Room 403 in a hotel in Beijing at 11 am on Jan. 10, 2012” to the first client, namely, the client corresponding to the demander, for the convenience of the demander to view the modified affair reminder information. In order to reduce the happening of the situation of the executer forgetting or losing an affair, the client corresponding to the executer and the client corresponding to the demander can communicate real-timely through the social software like QQ, MSN, microblog, etc.

If the received affair reminder information conflicts with the affair reminder information in current database, the second client deletes the received affair reminder information. For example, the second client receives affair reminder information of “Attend a classmate reunion in Room 403 in a hotel in Beijing at 11 am on Jan. 10, 2012” and inquires data information in the current database. If it is revealed that there is data information of an affair to attend at 10 am on Jan. 10, 2012, the second client notifies the executer of the affair reminder information, and the executer sends a deleting instruction. The second client receives a user deleting instruction of the client corresponding to the executer, and deletes the received affair reminder information.

In the various embodiments, a server is configured to send the affair reminder information to the second client according to the information of the second client, so that the second client can perform an affair reminding procedure according to the affair reminder information, where the server may be a server of QQ software, MSN, or microblog.

In the various embodiments, the affair reminder information sent by the first client is sent to the second client according to information of the second client, so that the second client can perform affair reminding according to the affair reminder information, and a function of automatically reminding the user is implemented so that the situation of the executer forgetting or losing an affair is prevented from happening. By adopting a technical means of cloud storage demand, it is convenient for the clients corresponding to the executer and the demander to gain the effects of uniform view, management practice, and conflict intelligent reminder, and the client corresponding to the executer and the client corresponding to the demander can interact with each other through the same social software and real-time communication between the two parties can be implemented.

With reference to FIG. 3, it shows challenges of the traditional method of affair reminder. It can be seen from FIG. 3 that the traditional method of affair reminder is that when a demander demands or requests the executer to remember the executing date of a certain affair, the demander is required to notify the executer orally or by way of email etc., and then the executer chooses his own way to record his affair schedule. The above procedure may have the following challenges, specifically as follow.

First, when the information is being passed on, the demander may not pass on the information clearly, or the executer may not pay enough attention, or the executer may be influenced by outside problems, so that the executer may not record the affair immediately, and the demand is forgotten or lost before being input into the device. Affair arrangement and communication usually happens within this period only, and it may happen that the executer is unclear of his affair arrangement during this period, leading to the situation that the promised demand conflicts with other affairs.

Second, when the executer is recording the affair and finds that the affair conflicts with others, the executer may modify or discard this affair, but his communication with the demander once again will consume certain costs.

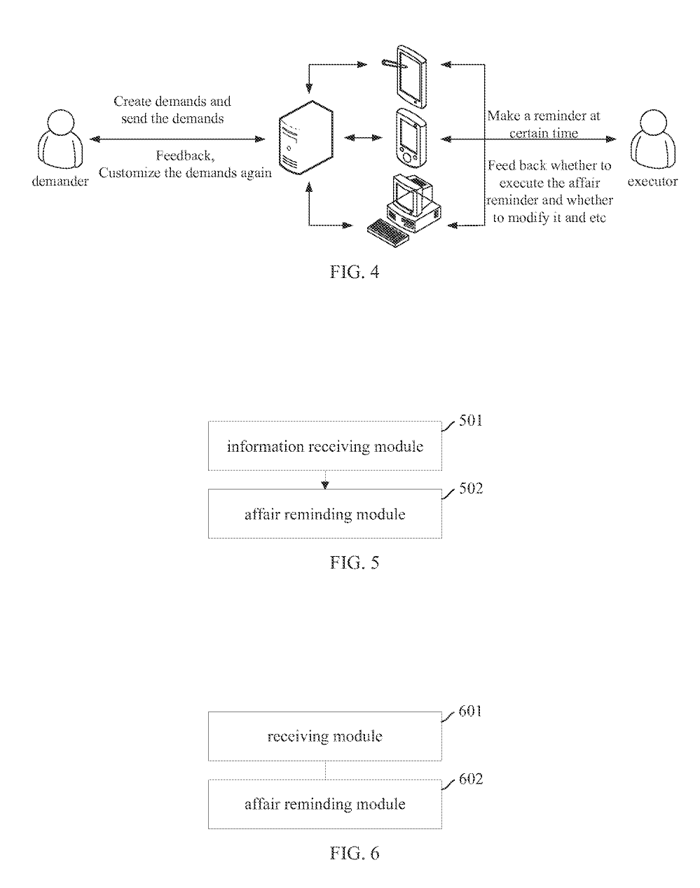

With reference to FIG. 4, it shows a structure of the method of affair reminder provided by the present disclosure.

The client corresponding to the demander creates a demand and sends affair reminder information and information of the client corresponding to the executer to the server. The server issues affair reminder information of the client corresponding to the demander to the client corresponding to the executer, and the client corresponding to the executer configures the received affair reminder information of the client corresponding to the demander to reminding software of the client corresponding to the executer for reminding. When the client corresponding to the executer receives an execution demand, it acknowledges whether to execute or not, and modifies the affair reminder information sent by the client corresponding to the demander. The affair reminder information modified by the client corresponding to the executer is returned to the server and the server feeds back the corresponding modified affair reminder information to the client corresponding to the demander. The client corresponding to the demander sets proper affair reminder information according to the feedback from the client corresponding to the executer.

In the above-mentioned method provided by the various embodiments, according to the information of the second client, the affair reminder information sent by the first client is sent to the second client, so that the second client can perform affair reminding according to the affair reminder information, and the function of automatically reminding the user is implemented and the situation of the executer forgetting or losing an affair is prevented from happening.

With reference to FIG. 5, the various embodiments provide a device of affair reminder, including the following. The various embodiments provide a device of affair reminder, which includes: an information receiving module 501 and an affair reminding module 502. The information receiving module 501 is adapted to receive from a first client affair reminder information and information of a second client. The affair reminding module 502 is adapted to, according to the information of the second client, send the affair reminder information to the second client, so as to enable the second client to perform affair reminding according to the affair reminder information. In the various embodiments, the affair reminder information includes an affair reminding topic, affair reminding time, affair reminding frequency, an affair reminding manner set by a user, etc.

The device according to the various embodiments can be applied in a server which may be a separate server or which may be a server integrated in a server of other applications, like a server of QQ software, MSN, microblog, etc.

In the above-mentioned device according to the various embodiments, according to the information of the second client, the affair reminder information sent by the first client is sent to the second client so that the second client can perform affair reminding according to the affair reminder information, and the function of automatically reminding the user is implemented, and the situation of the executer forgetting or losing an affair is prevented from happening.

With reference to FIG. 6, the various embodiments provide a second client of affair reminder, including the following. A receiving module 601 is adapted to receive affair reminder information. An affair reminding module 602 is adapted to perform affair reminding according to the affair reminder information received by the receiving module 601.

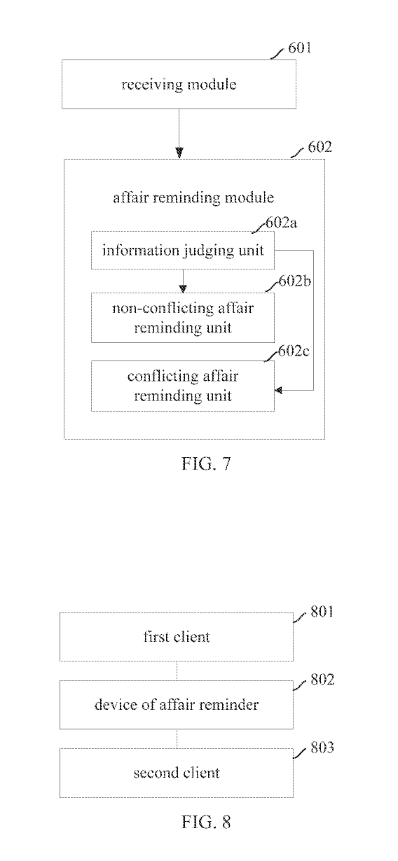

With reference to FIG. 7, this affair reminding module 602 includes an information judging unit 602a, a non-conflicting affair reminding unit 602b, and a conflicting affair reminding unit 602c. The information judging unit 602a is adapted to judge whether the affair reminding information received by the receiving module 601 conflicts with affair reminding information in the current database.

The non-conflicting affair reminding unit 602b is adapted to, if the information judging unit 602a determines that the affair reminder information does not conflict with the affair reminder information in the current database, add the affair reminder information received by the receiving module 601 to the current affair reminder information data table for affair reminding.

The conflicting affair reminding unit 602c is adapted to, if the information judging unit 602a determines that the affair reminder information conflicts with the affair reminder information in the current database, modify the affair reminder information received by the receiving module 601 and add the modified affair reminder information to the current affair reminder information data table for affair reminding, or delete the received affair reminder information.

In the various embodiments, the conflicting affair reminding unit 602c includes a conflicting affair information modifying subunit which is adapted to modify the affair reminder information received by the receiving module 601 according to a user modification command or a preset modification strategy.

In the various embodiments, the conflicting affair information modifying subunit further includes an information feedback subunit which is adapted to return the modified affair reminder information to the first client according to the preset modification strategy.

In the various embodiments, the affair reminder information includes an affair reminding topic, affair reminding time, affair reminding frequency, and an affair reminder manner set by the user.

The second client according to the various embodiments, by receiving the affair reminder information, performs affair reminding according to the affair reminder information, so that a function of automatically reminding the user is implemented, and the situation of the executer forgetting or losing an affair is prevented from happening. By adopting a technical means of cloud storage demand, it is convenient for the clients corresponding to the executer and the demander to gain the effects of uniform view, management practice, and conflict intelligent reminder, and the client corresponding to the executer and the client corresponding to the demander can interact with each other through the same social software and real-time communication between the two parties can be implemented.

With reference to FIG. 8, the various embodiments provide a system of affair reminder, and the system includes a first client 801, a device of affair reminder 802, and a second client 803. The first client 801 is adapted to send affair reminder information and information of the second client to the device of affair reminder.

The device of affair reminder 802 includes an information receiving module which is adapted to receive from the first client the affair reminder information and the information of the second client, and a first affair reminding module which is adapted to, according to the information of the second client received by the receiving module, send the affair reminder information to the second client.

The second client 803 includes a receiving module which is adapted to receive affair reminder information sent by the device of affair reminder, and a second affair reminding module, which is adapted to perform affair reminding according to the affair reminder information received by the receiving module.

The above-mentioned system provided by the present embodiment, according to the information of the second client, sends the affair reminder information sent by the first client to the second client, so that the second client can perform affair reminding according to the affair reminding information, and a function of automatically reminding the user is implemented, and the situation of the executer forgetting or losing an affair is prevented from happening. By adopting a technical means of cloud storage demand, it is convenient for the clients corresponding to the executer and the demander to gain the effects of uniform view, management practice, and conflict intelligent reminder, and the client corresponding to the executer and the client corresponding to the demander can interact with each other through the same social software and real-time communication between the two parties can be implemented.

The device of affair reminder according to the various embodiments is described by taking an example of dividing it into several functional modules in an affair reminding procedure and, in practical application, the above-mentioned functions can be accomplished by different functional modules according to practical demands; namely, the device's internal structure can be divided into different functional modules, so as to accomplish all or a part of the above-described functions. In addition, the device of affair reminder according to the various embodiments and the embodiments of the method of affair reminder belong to the same idea, and its specific implementation processes can be referred to the method embodiments, which is not to be illustrated any more hereby.

Serial numbers of the embodiments in the present disclosure are simply for purposes of illustration and do not represent the superior and inferior of the various embodiments.

One skilled in the art will understand that all or a part of the blocks of the various embodiments may be implemented through hardware or may be implemented through related hardware being instructed by a program, and the program may be stored in a computer-readable storage medium, and the storage medium may be a read-only memory, a magnetic disk or an optical disk or etc.

The above description of the various embodiments of the present disclosure, but not used to limit the present disclosure, and any modification, equivalent replacement and improvement within spirit and principle of the present invention are within the protection scope of the present invention. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method of affair reminder, comprising:
receiving from a first client affair reminder information and information of a second client; and
sending the affair reminder information to the second client according to the information of the second client so as to enable the second client to perform affair reminding according to the affair reminder information.

2. The method according to claim 1, wherein the method further comprises:
receiving, by the second client, the affair reminder information, and judging whether the received affair reminder information conflicts with affair reminder information in a current database; and
when the received affair reminder information does not conflict with the affair reminder information in the current database, the second client adding the received affair reminder information to a current affair reminder information data table for affair reminding; and
when the received affair reminder information conflicts with the affair reminder information in the current database, the second client modifying the received affair reminder information and adding the modified affair reminder information to the current affair reminder information data table for affair reminding, or the second client deleting the received affair reminder information.

3. The method according to claim 2, wherein a process of the second client modifying the received affair reminder information specifically comprises:
the second client modifying the received affair reminder information according to a user modification instruction; or
the second client modifying the received affair reminder information according to a preset modification strategy.

4. The method according to claim 3, wherein after the second client modifying the received affair reminder information according to the preset modification strategy, the method further comprises:
the second client feeding back the modified affair reminder information to the first client.

5. The method according to claim 1, wherein, the received affair reminder information comprises an affair reminding topic, affair reminding time, affair reminding frequency and an affair reminding manner set by a user.

6. A device of affair reminder, comprising:
an information receiving module, adapted to receive from a first client affair reminder information and information of a second client; and
an affair reminding module, adapted to send the affair reminder information to the second client according to the information of the second client received by the information receiving module so as to enable the second client to perform affair reminding according to the affair reminder information.

7. The device according to claim 6, wherein, the affair reminder information comprises an affair reminding topic, affair reminding time, affair reminding frequency and an affair reminding manner set by a user.

8. A client of affair reminder, comprising:
a receiving module, adapted to receive affair reminder information; and
an affair reminding module, adapted to perform affair reminding according to the affair reminder information received by the receiving module.

9. The client according to claim 8, wherein, the affair reminding module comprises:
an information judging unit, adapted to judge whether the affair reminder information received by the receiving module conflicts with affair reminding information in a current database;
a non-conflicting affair reminding unit, adapted to, when the information judging unit determines that the affair reminder information received does not conflict with the affair reminder information in the current database, add the affair reminding information received by the receiving module to a current affair reminding information data table for affair reminding; and
a conflicting affair reminding unit, adapted to, when the information judging unit determines that the affair reminder information received conflicts with the affair reminder information in the current database, modify the affair reminder information received by the receiving module and add the modified affair reminder information to the current affair reminding information data table for affair reminding, or delete the affair reminder information received by the receiving module.

10. The client according to claim 9, wherein, the conflicting affair reminding unit comprises:
a conflicting affairs information modifying subunit, adapted to modify the affair reminder information received by the receiving module according to a user modification instruction or a preset modification strategy.

11. The client according to claim 10, wherein, the conflicting affairs information modifying unit further comprises:
an information feedback subunit, adapted to feed back the affair reminder information modified according to the preset modification strategy to another client.

12. The client according to claim 8, wherein, the affair reminder information comprises an affair reminding topic, affair reminding time, affair reminding frequency and an affair reminding manner set by a user.
